(19) United States
(12) Patent Application Publication
(10) Pub. No.: US 2006/0092647 A1
(43) Pub. Date: May 4, 2006

(54) Bicycle spoke light

(76) Inventor: Sean V. Glasser, Jersey City, NJ (US)

Correspondence Address: Donal W. Meeker;Patent Agent, 924 East Ocean Front #E, Newport Beach, CA, 92661, US

(21) Appl. No.: 10/977,904

(22) Filed: Oct. 30, 2004

(51) Int. Cl. B60Q 1/26

(52) U.S. Cl. 362/473; 362/500; 362/800; 362/208; 362/202; 362/241; 362/244; 362/276

(57) ABSTRACT

A light in a streamlined casing attaches to a spoke of a bicycle wheel. A light viewing area which may have a clear plastic window surrounds most of the surface of the casing. Two LED lights interconnected by a light tube in front of a mirrored reflector transmit light through the viewing area. Two AAA batteries or three size N batteries mounted behind the reflector power the light. A printed circuit board enables a control button on the casing to program the LED lights to produce various light effects in the LED lights including a fast flash, a slow flash, and a steady light. A series of bicycle wheel lights mounted on spokes around a bicycle wheel produce an image of a wheel of light as the bicycle wheel rotates in traveling.

### BACKGROUND OF THE INVENTION

1. Field of the Invention

The present invention relates to devices used to provide safety after dark for bicycles, and particularly to a device that provides an illumination by two light emitting diodes (LEDs) with a fiber optic line running between them, said device is housed in a pen-sized case that clips onto a bicycle spoke and is in motion with the rotation of the bicycle wheel.

2. Description of the Prior Art

For both fitness and recreation, bicycling has seen increased popularity in recent years. As such an economical and efficient mode of transportation, our roadways are now more crowded with bicyclists than ever before. As more and more cyclists take to the roads, the need for better bicycle safety equipment becomes more important. The need for safer, more visible bicycles is heightened in periods of low natural light and diminished visibility, such as nighttime.

Reflectors or lights mounted on a bicycle serve to protect the bicycle enthusiast from oncoming motorists sharing the roadways, primarily during nighttime riding. Visibility of the cyclist is paramount, as the sooner the motorist sees the bicycle rider, the quicker the motorist can react and subsequently avoid the cyclist. Lights placed on the spokes of the bicycle wheels increase visibility due to the rotation of the bicycle wheels.

U.S. Pat. No. 6,501,199, issued Dec. 31, 2002 to Hung, describes an automatic wheel-driven generating means and lighting device thereof. The automatic wheel-driven generating device mainly includes a base fixedly mounted on a wheel around an axle thereof and provided with a centered hollow column and one or more radially extended hollow pipes for each receiving a light-emitting element therein; a winding reel enclosed between left and right magnetic poles and fixedly mounted on the hollow column; and a magnet holder having a cap screwed into a center thereof and being fixedly mounted on the axle. The magnet holder carries magnets and is associated with the winding reel and the magnetic poles without contact with them. When the wheel rotates, the winding reel and the magnetic poles on the base rotate along with the wheel relative to the magnet holder that is unmovably fixed on the axle, so that an induced current is produced to drive the light-emitting elements to emit light beams. Each of the light-emitting elements is associated with a light-guiding bar that is connected to the wheel and has an uneven outer surface, so that light emitted from the light-emitting element is reflected and refracted in the light-guiding bar, making the whole rotating wheel a bright light circle to ensure a rider's safety.

U.S. Pat. No. 5,984,487, issued Nov. 16, 1999 to McGhee, provides a bicycle visibility enhancement device, which is powered by electricity from an on board battery and is securely attached to one or more of the wheels of a bicycle. The bicycle visibility enhancement device includes a left housing and right housing which are both semi-circular and can be secured together through bolts sandwiching the axle of the bicycle wheel there between, adjacent troughs. Battery bores are provided within the housings to support the batteries, which provide electricity to the bicycle visibility enhancement device. At least two light assemblies are provided, one extending from each housing and oriented to direct light away from the housings. Wiring couples the batteries to the light assemblies. Each light assembly has a light refraction tube extending from the housing out to the rim of the bicycle wheel. The light refraction tube is conical and formed of translucent material such that light emanating from the light assembly is refracted through a conical surface of the light refraction tube and the entire light refraction tube is illuminated. Hence, the wheels of the bicycle are provided with significant visibility enhancement, especially when rotating.

U.S. Pat. No. 5,121,305, issued Jun. 9, 1992 to Deed, is for a device which provides a source of light for a wheeled vehicle such as a bicycle to provide warning of the presence of the vehicle and any person or rider. The device uses a battery power pack that may be rechargeable, which mounts around the axle of a wheel of the vehicle. A string of light emitting diodes contained in a clear sealed flexible tube is electrically connected to the power pack. The power pack and tube rotate with the wheel and provide an active light source for others to see such as drivers of automobiles. The device is especially useful on spoke wheels such as bicycles.

U.S. Pat. No. 6,492,963, issued Dec. 10, 2002 to Hoch, shows an electronic display apparatus that is mounted on the spokes of a rotating bicycle wheel. The display includes a plurality of arrays of lights, each array attached to one of the spokes. A sensor on the wheel, actuated by a magnet mounted on the frame, senses the angular velocity of the rotating wheel with respect to the bicycle frame. A microprocessor, mounted on the wheel and connected to the sensor, and individually connected to each of the plurality of arrays of lights by a cable, includes a memory which stores a plurality of display patterns. The microprocessor modulates the plurality of arrays of light according to a selected one of the plurality of display patterns and the sensed angular velocity of the rotating wheel to form an image using persistence of vision of a viewer.

U.S. Pat. No. 5,418,697, issued May 23, 1995 to Chiou, shows a signal lamp assembly for bicycles. The signal lamp assembly includes a casing fixed to the spokes of a bicycle wheel, two tubular, light permeable lampshades connected to two opposite ends of the casing, and a lamp circuit unit installed in the casing and the lampshades and consisting of a battery, a manual switch, a reversing switch, and a series of light emitting diodes disposed in the lampshades and controlled to give light by the manual switch and the reversing switch. The reversing switch is alternatively switched on and off when the bicycle wheel is turned round and round after the manual switch is switched on, causing the light emitting diodes to flash.

U.S. Pat. No. 2,811,633, issued Oct. 29, 1957 to Bjork, discloses a safety bicycle light that comprises a miniature flashlight, the casing of which includes a pair of spaced means for securing the flashlight between a pair of spokes of a bicycle wheel. The flashlight is securely retained for rotation with the wheel, thereby clearly indicating the direction of travel of the bicycle.

U.S. Patent Application #20020163817, published Nov. 7, 2002 by Bukowsky, discloses a bicycle lighting system that has a lighting mechanism attached to a wheel of the bicycle. As the wheel revolves, an actuator activates the light at a predetermined point. The actuation may be physical or electromagnetic in nature. The actuation triggers the lighting of light contained in the lighting mechanism. The light beams may emanate parallel to the path defined by the spokes, or perpendicular to the emanating spokes. To an observer from the front, the light travels downward over the effective wheel height, transforming the light into an elongated light source equal to the wheel height. The rate at which the light source travels downward gives rotational information. The lighting may be for a predetermined time or either of the lights may be strobed. A timing circuitry sensitive to rotational information allows the lights to be switched on and off at predetermined times and/or points in the revolution of the wheel. Delays may be introduced, and strobing effects may be also introduced. In an exemplary aspect, the strobe rate may set at a rate proportional to the revolution rate.

U.S. Patent Application #20020057574, published May 16, 2002 by Dalton, indicates a lighting device for attaching to a spoked wheel, which emits light in the direction of the rim of the wheel, and in a direction parallel to the axis of rotation of the wheel. The wheel lighting device has a housing in an aerofoil shape.

U.S. Patent Application #20030112632, published Jun. 19, 2003 by Forsythe, puts forth a cycle wheel safety lighting system. The cycle wheel safety light system uses double-sided shaped A-C electro-luminescent light panels, spaced about the wheels of a bicycle. A DC battery powers the panels via a DC-AC inverter. Alternatively, an alternator mounted between the wheel axle and frame utilizes the bicycle rider's motive power as the source of energy. Another variation combining the best features of both the battery and inverter is use of an alternator to charge (via a rectifier) a smaller battery or other energy storage device such as a ‘supercap’. The panels may be of various colors to improve the “WOW!” factor and encourage adolescent use.

U.S. Pat. No. 5,624,175, issued Apr. 29, 1997 to Gelormino, provides a safety light for a bicycle. A housing member supports a power source and at least one light source. The light source is electrically connectable to the power source. A motion sensitive switch switches between an open condition and a closed condition in response to motion of the housing member. A control circuit is activated dependent on the open and the closed condition of the motion switching means. The control circuit produces a flashing voltage pulse effective to cause the at least one light source to flash on and off. The control circuit also detects an on-off cycle each time the switching means switches between the open condition and the closed condition in response to motion of the housing member and produces a flashing voltage pulse for a predetermined length of time after detecting a last on-off cycle. In another embodiment, the power source comprises a magnetic member for providing a magnetic field and a conductive coil disposed relative to the magnetic member so that motion of the magnetic member relative to the conductive coil in response to motion of the housing member produces an electric current. In still another embodiment, the power source includes piezo-electric elements, which generate electricity when struck by a moving weight. At least one light source supported by the housing member is electrically connectable to the power source for receiving the electric current in response to motion of the housing member.

U.S. Pat. No. 6,170,968, issued Jan. 9, 2001 to Caswell, claims a motion activated rotatable illuminator that has all of its electrical components mounted within a housing, which is secured to the rotatable object. Those components include a light source, an electrical power source, a first switch activated by intermittent motion of the housing and a second switch activated by centrifugal forces caused by rotation of the rotatable object. The illuminator components also include a timer which has a timing cycle and which is operably connected relative to the first switch and the second switch such that activation of either the first switch or the second switch initiates that timing cycle of the timer and enables the flow of electricity from the power source to the light source during the timing cycle. The light source can include an electro luminescent strip or light emitting diodes. As noted the illuminator can be mounted on a rotatable object, or can be used by wearing on a person, pet or other device to provide a warning or locator light.

U.S. Pat. No. 5,839,814, issued Nov. 24, 1998 and U.S. Pat. No. 5,653,523, issued Aug. 5, 1997 both to Roberts, describes a miniaturized lighting apparatus for a rotating object that includes a light-emitting diode (LED), a centrifugal switch, a tiny 3-volt power source, and electrical conduits. The switch is configured to provide power to the LED only upon application of a specific centrifugal force. As applied to an in-line roller skate wheel, the switch and LED may be sealed within the wheel, and the batteries never need replacement because the battery life exceeds the expected wheel life. An in-line skate wheel incorporating the lighting apparatus within it is activated to light the wheel at a predetermined centrifugal force equivalent to a given rotational speed of the wheel, such as 80 rpm. As applied to a reflector light for a bicycle wheel, the light draws power from the battery(ies) only while the wheel is turning at a minimum predetermined rotational speed such as 20 rpm. As applied to a rotatable flying disc, lighting apparatus are mounted on opposite sides of the disc, near the disc periphery. The switch is constructed to actuate the LED at a low rotational speed, and the disc itself is constructed of a phosphorescent material with persistent afterglow. Alternatively, a time delay may be incorporated into the lighting circuit to provide a delayed shut-off of current to the LED.

U.S. Pat. No. 5,102,362, issued Apr. 7, 1992 to Denen, indicates an illuminator assembly, which is formed from a light emitting diode (LED) having two electrode pins extending therefrom which are cut to predetermined lengths. One lead then is formed to provide a circularly shaped spring support base and the other lead is bent to provide an attachment portion extending through the center of the opening formed by the spring support base. A capture spring of conical configuration then is attached to the centrally disposed lead, which extends through the spring support base opening. A compressible coil switching spring then is attached to the spring support base. The assemblage thus formed is employed with a battery of a variety having a forward face which engages the free end of the switching spring and which includes a rod shaped electrode extending from the center portion thereof. Upon providing relative mutually approaching movement of a battery and illuminator assembly, the rod-like cathode is engaged by the capture spring and an electrical circuit is completed to illuminate the LED. Conversely, the releasing or reverse movement under the drive imparted by the switching spring switches the assemblage to an open circuit condition.

U.S. Pat. No. 5,058,900, issued Oct. 22, 1991 to Denen, puts forth an illuminator assembly, which is formed from a light emitting diode (LED) having two electrode pins extending therefrom which are cut to predetermined lengths. One lead then is formed to provide a circularly shaped spring support base and the other lead is bent to provide an attachment potion extending through the center of the opening formed by the spring support base. A capture spring of conical configuration then is attached to the centrally disposed lead, which extends through the spring support base opening. A compressible coil switching spring then is attached to the spring support base. The assemblage thus formed is employed with a battery of a variety having a forward face which engages the free end of the switching spring and which includes a rod shaped electrode extending from the center portion thereof. Upon providing relative mutually approaching movement of a battery and illuminator assembly, the rod-like cathode is engaged by the capture spring and an electrical circuit is completed to illuminate the LED. Conversely, the releasing or reverse movement under the drive imparted by the switching spring switches the assemblage to an open circuit condition.

U.S. Pat. No. 5,477,427, issued Dec. 19, 1995 to Forman, concerns a self-contained illuminated reflector device for mounting to the spoke of a wheel, which includes a housing having a spoke receiving slot for mounting the reflector to the spoke, and a cavity included in the housing; mounted within the cavity are a fiber-optic light bulb and a battery holder which is electrically connected to the light bulb, and is adapted to receive a battery for selectively providing current to the light bulb.

U.S. Pat. No. 4,176,390, issued Nov. 27, 1979 to Galbert, claims a light adapted to be connected to a wheel of, for example, a bicycle. In preferred form, the light is fixed to the wheel in a manner that orients the light's battery on an axis positioned substantially radially of the wheel, and that orients the light's battery radially inward of the light's bulb relative to the wheel's axis. A switch spring is provided in the light's housing that normally biases the battery out of electrical contact with the bulb when the wheel is not rotating, i.e., when the bicycle is not in use, but which permits the battery to be biased into electrical contact with the bulb in response to centrifugal force when the wheel is rotating, i.e., when the bicycle is in use. Thus, the light turns off automatically when the bicycle is not being ridden, and turns on automatically in response to centrifugal force when the bicycle is being ridden, when the light is mounted on a bicycle's wheel.

What is needed is a highly visible light for bicycles which is lightweight and produces a maximum light effect with a minimal amount of power.

### SUMMARY OF THE INVENTION

An object of the present invention is to provide a bicycle light with a pair of LED lights interconnected by a light rod, such as a fiber optic rod, which transmits and disperses the light from each LED positioned in front of a highly reflective mirrored surface and powered by batteries (preferably two lightweight AAA or three size N camera type batteries) contained in preferably a streamlined shiny lacquer finished case attachable to a bicycle spoke for a highly visible light for bicycles which is lightweight and produces a maximum light effect with a minimal amount of power.

A related object of the present invention is to provide an elongated hinged clip along the length of the clip for attaching the bicycle light to a section of a spoke sandwiched between the clip and the casing so that the bicycle light spins with the bicycle spoke as the wheel turns to create a moving wave of light.

A further related object of the present invention is to provide a bottom extension of the elongated clip for securing a second spoke between the elongated clip and the casing at a point where the second spoke crosses over the primary spoke to which the device is secured to help prevent rotation of the device around the spoke to which it is primarily attached.

Another related object of the present invention is to provide a spoke attachable light as indicated above that produces a solid wheel of light when several are attached or partial wheel of light when one is attached around the spokes of a bicycle wheel as the wheel rotates in traveling.

Another object of the present invention is to provide a programmable printed circuit board and a control button in the power circuit of the bicycle light to produce various light effects such as fast flash, slow flash, and steady light.

In brief, a bicycle light is housed in a streamlined shiny lacquer finished streamlined case attachable to a bicycle spoke. A pair of LED lights are interconnected by a light rod running the length of the case, which light rod transmits the light from each LED. The light rod and LEDs are positioned in front of a highly reflective mirrored surface to enhance the light effect. The light is powered by batteries (preferably two lightweight AAA or three size N camera type batteries) contained in the case behind the mirrored reflector.

A programmable printed circuit board and a control button in the power circuit of the bicycle light produce various light effects such as fast flash, slow flash, and steady light as well as off.

By attaching several of the lights around the wheel on several spokes, the light can produce a solid wheel of light as the wheel rotates in traveling.

With various light effects and a maximum output of light for a minimum of power the bicycle light of the present invention provides a highly visible light for bicycles which is lightweight and produces a maximum light effect.

A related advantage of the present invention is that it provides a spoke attachable light that is capable of producing a solid wheel of light when several are attached around the spokes of a bicycle wheel as the wheel rotates in traveling.

Another advantage of the present invention is that it can produce various light effects such as fast flash, slow flash, and steady light.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a front elevational schematic view of the bicycle wheel light of the present invention showing the casing with the clear window covering the light source, the control button, and the batteries inside the casing with the battery cover removed;

FIG. 2 is a schematic cross-sectional view taken through the centerline of the bicycle wheel light of FIG. 1 showing the two LEDs interconnected by a light rod in front of a mirrored reflector, the two batteries and the printed circuit board;

FIG. 3 is a schematic side elevational view of the bicycle wheel light of FIG. 1 mounted on a spoke showing the clear window in front of the light source covering the face of the casing and the clips attaching the bicycle wheel light to a spoke of the wheel;

FIG. 4 is a schematic back elevational view of the bicycle wheel light of FIG. 1 mounted on a spoke showing the clear window in front of the light source and the clip attaching the bicycle wheel light to a spoke of the wheel;

FIG. 5 is a schematic top plan view of a clip showing the two screws into the casing and the opening for the spoke to fit between the clip and the casing;

FIG. 6 is a schematic front elevational view of a bicycle wheel having six of the bicycle lights of FIG. 1 mounted on spokes around the wheel;

FIG. 7 is a partial perspective view showing the bicycle wheel light being attached to a spoke of a bicycle wheel.

### BEST MODE FOR CARRYING OUT THE INVENTION

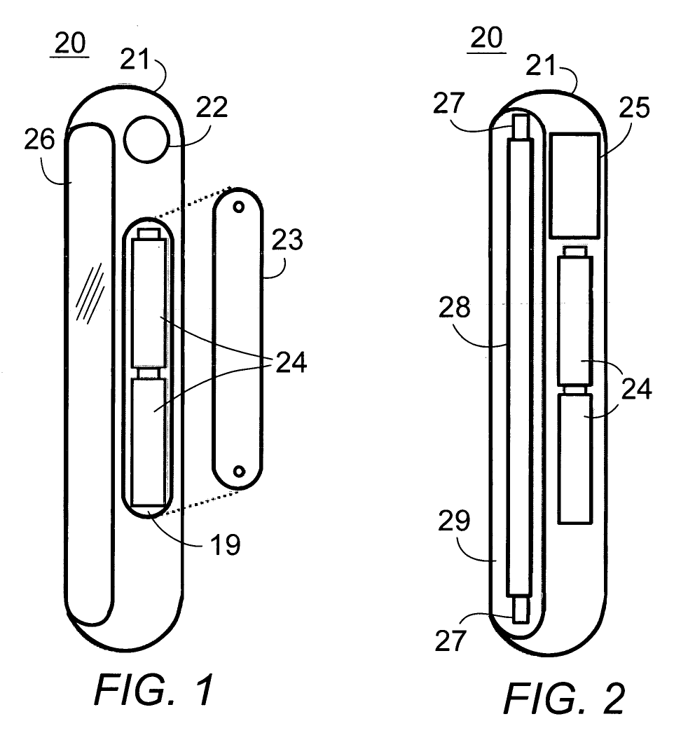

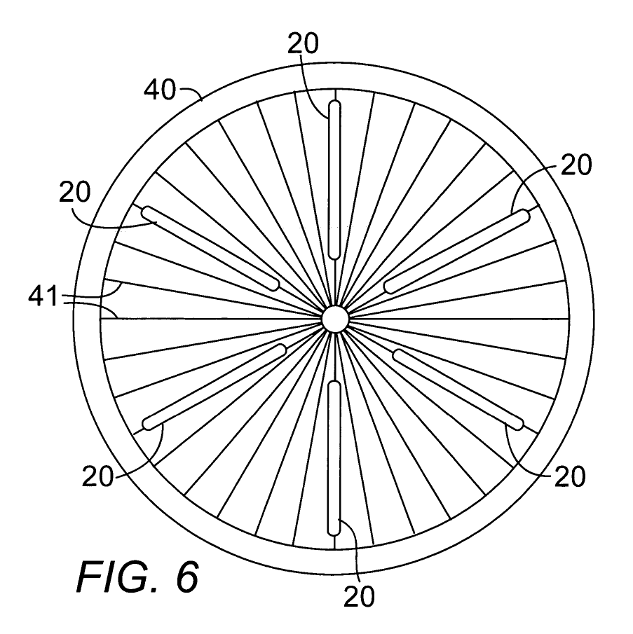

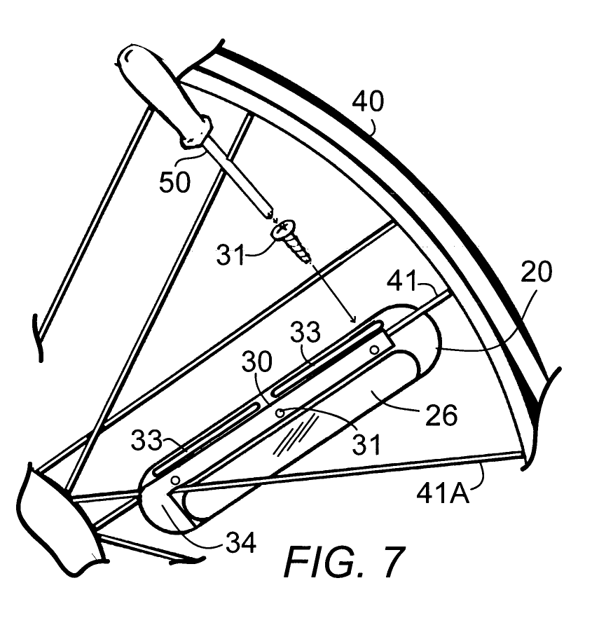

In FIGS. 1-7, a bicycle wheel light device 20 attaches in parallel to a spoke 41 of a bicycle wheel 40, as shown in FIGS. 6 and 7. The device comprises an elongated casing 21 adapted for parallel attachment to a spoke of a bicycle wheel 41. The casing 21 is formed in a rigid elongated shell enclosing an interior space 19. A light viewing area which may have a clear plastic window 26 wraps around a majority of a perimeter of the casing along the length of the casing. A control button 22 is mounted on an exterior of the casing and a battery cover 23 removably attaches to the casing over a battery insertion opening admitting batteries 24 therethrough.

A pair of LED lights 27 are mounted in the interior space 19 of the casing positioned behind the clear plastic window 26 with each LED light positioned adjacent to an end of the casing and a light rod 28 interconnects the two LED lights along the length of the clear plastic window 26. The light rod 28 is adapted for transmitting and dispersing the light from each LED light 27 and is preferably a fiber optic rod. A reflective surface 29 is attached inside the interior space of the casing behind the LED lights 27 and the light tube 28, the reflective surface adapted for reflecting light from the LED lights and the light tube out through the light viewing area which may have a clear plastic window 26.

A battery means, preferably a pair of lightweight AAA batteries 24 or three size N batteries, powers the LED lights 27. The batteries 24 are removably mounted in the interior space of the casing. They are electrically connected to the control button 22 and the LED lights 27 so that the control button 22 is adapted for turning the power for the battery means to the LED lights 27 on and off.

A printed circuit board 25 positioned within the interior space 19 of the casing 21 is electrically attached the control button 22 and the LED lights 27, and the printed circuit board 25 is adapted for enabling the control button 22 to produce various light effects in the LED lights including a fast flash, a slow flash, and a steady light.

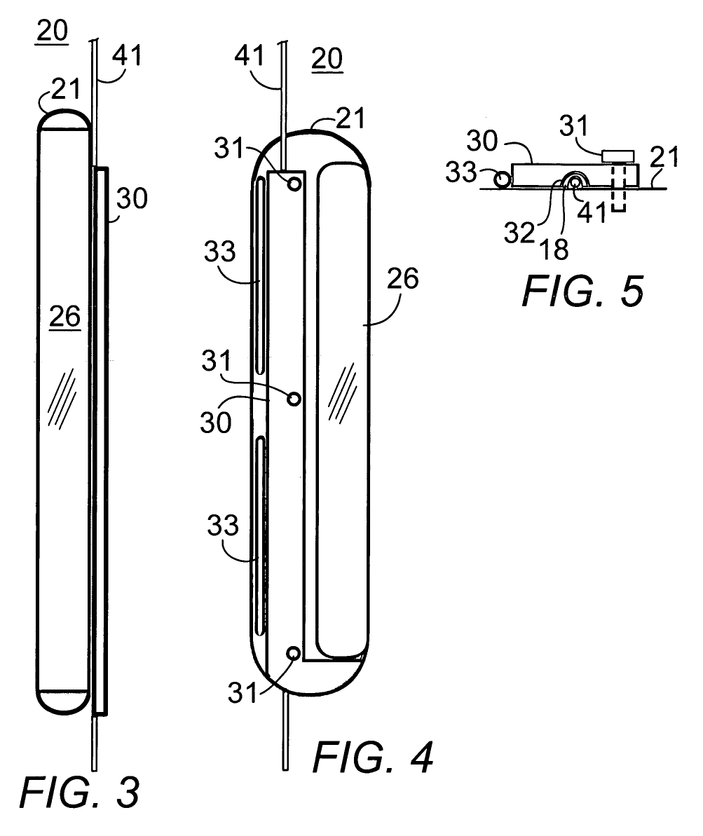

In FIGS. 3-5 and 7, the means for attaching the bicycle wheel light 20 to a spoke 41 of a bicycle wheel 40 comprises an elongated clip 30 attached to the casing 21 along most of the length of the casing by a hinge 33 on one long side of the clip for pivoting the clip to admit a section of a spoke 41 between the clip 30 and the casing 21 and a series of holes with screws 31 on another long side of the clip for securing the clip to the casing with a screwdriver 50. In FIG. 7, a second adjacent spoke 41A crosses over the spoke 41 to which the bicycle wheel light is attached. The second spoke 41A is also secured under a bottom section of the clip 30 at the point where the two spokes cross to prevent the bicycle wheel light casing 21 from spinning around the spoke 41 to which it is primarily attached.

In FIG. 5, the clip has a recessed groove 32 forming a spoke opening along the length of the clip for receiving a spoke 41 in the groove 32, the clip structured to crimp a section of a spoke of a bicycle wheel securely against the casing to prevent movement therebetween. A flexible insert 18, such as a strip of foam rubber, in the groove 32 between the clip and a spoke compresses the section of the spoke 41 against the casing and thereby allows the device to accommodate any of a variety of different sizes of spokes. to prevent dislodging the bicycle wheel light 20 from the spoke 41 during movement of the wheel 40.

The casing 21 preferably comprises a molded tubular shell with rounded ends which may be coated with a shiny lacquer finish.

In FIG. 6, the bicycle wheel light is adapted for mounting one or a series of spaced bicycle wheel lights 20 on different spokes 41 around a bicycle wheel 40 to produce a visual effect of a wheel of light or partial wheel of light as a bicycle wheel rotates in traveling with the bicycle wheels lights mounted thereon.

It is understood that the preceding description is given merely by way of illustration and not in limitation of the invention and that various modifications may be made thereto without departing from the spirit of the invention as claimed.

What is claimed is:

1. A bicycle wheel light device for attachment to a spoke of a bicycle wheel, the device comprising:
an elongated casing structured to be attached to a spoke of a bicycle wheel in parallel alignment with a spoke, the casing formed in a rigid elongated shell enclosing an interior space, a light viewing area around a majority of a perimeter of the casing along the length of the casing, a control button mounted on an exterior of the casing, the casing having a battery insertion opening therethrough and a battery cover removably attachable to the casing over the battery insertion opening;
a pair of LED lights mounted in the interior space of the casing positioned in the light viewing area with each LED light positioned adjacent to an end of the casing and a light rod interconnecting the two LED lights along the length of the viewing area, the light rod configured to transmit the light from each LED light;
a battery means for powering the LED lights mounted in the interior space of the casing and electrically connected to the control button and the LED lights, the control button controlling the power transmission of the battery means to the LED lights;
a means for attaching the bicycle wheel light to a spoke of a bicycle wheel.

2. The device of claim 1 wherein the light viewing area is covered by a clear plastic window.

3. The device of claim 1 further comprising a reflective surface inside the interior space of the casing behind the LED lights and the light tube, the reflective surface reflecting light from the LED lights and the light tube out through the light viewing area.

4. The device of claim 3 wherein the battery means comprises two AAA batteries removably secured in the case behind the reflective surface.

5. The device of claim 3 wherein the battery means comprises three size N batteries removably secured in the case behind the reflective surface.

6. The device of claim 1 further comprising a printed circuit board positioned within the interior space of the casing and electrically attached the control button and the LED lights, the printed circuit board being actuated by the control button to produce various light effects in the LED lights including a fast flash, a slow flash, and a steady light.

7. The device of claim 1 wherein the means for attaching the bicycle wheel light to a spoke of a bicycle wheel comprises an elongated clip attached to the casing along most of the length of the casing by a hinge means on one long side of the clip for pivoting the clip to admit a spoke between the clip and the casing and a series of holes with screws on another long side of the clip for securing the clip to the casing, the clip having a recessed groove along the length of the clip for receiving a spoke in the groove, the clip structured to crimp a section of a spoke of a bicycle wheel securely against the casing to prevent movement therebetween.

8. The device of claim 7 further comprising a flexible insert in the groove between the clip and a spoke to compress a spoke against the casing and thereby accommodate any of a variety of different sizes of spokes.

9. The device of claim 7 wherein the elongated clip further comprises a bottom extension of the clip for securing a second spoke between the elongated clip and the casing at a point where the second spoke crosses over a spoke to which the device is secured to help prevent rotation of the device around a spoke to which it is primarily attached.

10. The device of claim 1 wherein the casing comprises a molded tubular shell with rounded ends.

11. The device of claim 1 wherein the bicycle wheel light is adapted for mounting a series of spaced bicycle wheel lights on different spokes around a bicycle wheel to produce a visual effect of a wheel of light as a bicycle wheel rotates in traveling with the bicycle wheels lights mounted thereon.

12. The light rod comprises a fiber optic rod.
